(19) United States
(12) Patent Application Publication
(10) Pub. No.: US 2014/0304676 A1
(43) Pub. Date: Oct. 9, 2014

(54) ELECTRONIC ELEMENT DESIGN SYSTEM AND METHOD

(71) Applicant: HON HAI PRECISION INDUSTRY CO., LTD., New Taipei (TW)

(72) Inventor: CHUNG-LUN HSU, New Taipei (TW)

(73) Assignee: HON HAI PRECISION INDUSTRY CO., LTD., New Taipei (TW)

(21) Appl. No.: 14/244,004

(22) Filed: Apr. 3, 2014

(30) Foreign Application Priority Data
Apr. 8, 2013 (TW) 102112288

(51) Int. Cl. G06F 17/50

(52) U.S. Cl. CPC G06F 17/5068; G06F 17/5009
USPC 716/136

(57) ABSTRACT

An exemplary electronic element design method includes determining an element value, and determining an element value range. The method searches a stored bill of material table to determine groups of electronic elements, determines the accuracy of the groups of electronic elements, and obtains the information of the determined groups of electronic elements with the determined accuracy. The method also determines the parameters of each model number of each group of electronic element with the determined accuracy, inputs all the determined parameters into an obtained transfer function to generate actual values to determine whether one or more actual values satisfy a reference rule. The method can determine that the electronic elements with the model numbers corresponding to each determined actual value are eligible. The method can control a display unit to display the information of the electronic element with the determined model numbers.

### FIELD

The present disclosure relates to electronic element design systems, and particularly, to an electronic element design system capable of employing economical electronic elements and a related method.

### BACKGROUND

Usually, because electronic elements with low accuracy have low cost, a number of electronic elements with low accuracy are preferred to be employed in a circuit to achieve a particular function for economy. As is known, the circuit may include different types of electronic elements. Each type of electronic element includes a number of electronic elements with different model numbers, and each model number of electronic element includes a number of parameters, such as temperature coefficient, initial tolerance. A common electronic element design method inputs the parameters of the electronic elements with low accuracy to a transfer function corresponding to the circuit, to determine whether all of the electronic elements with low accuracy corresponding to the circuit are eligible. If all of the electronic elements with low accuracy corresponding to the circuit are ineligible, electronic elements with high accuracy, which are the same type with the preferred employed electronic elements, are employed to satisfy the requirements of the circuit. However, each type of electronic element with high accuracy is more expensive than the corresponding type of electronic element with low accuracy. Thus, the cost of the circuit increases.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a block diagram of an electronic device in accordance with an exemplary embodiment.

FIG. 2 is a flowchart of an electronic element design method in accordance with an exemplary embodiment.

### DETAILED DESCRIPTION

The embodiments of the present disclosure are now described in detail, with reference to the accompanying drawings.

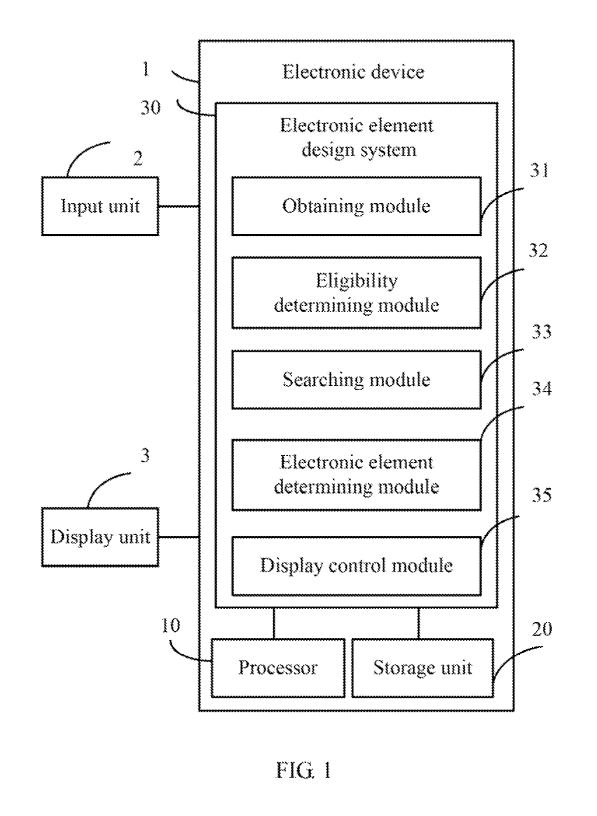

FIG. 1 illustrates an embodiment of an electronic device 1. The electronic device 1 determines the electronic elements with low accuracy capable of being employed in a circuit. In the embodiment, the electronic elements include, but are not limited to, resistors, capacitors, and inductors. Each circuit employs a number of different types of electronic elements. Each type of electronic elements are the electronic elements with a same element value (i.e., a same resistance value, a same capacitance value, a same inductance value), and each type of electronic elements includes a number of electronic elements with different model numbers which can be a vendor serial number used to identify the electronic elements. Taking resistors with 5 ohms for example, the resistors with 5 ohms can include two model numbers, for example, a model number “WF04U2211DTL” and a model number “WR04X4220FTL”. The electronic element with a model number includes a number of parameters, such as temperature coefficient, initial tolerance. The electronic device 1 is connected to an input unit 2 and a display unit 3. The electronic device 1 determines whether all of the electronic elements with the low accuracy corresponding to a selected circuit are eligible in response to user operation on the input unit 2. In addition, the electronic device 1 replaces the electronic elements with the low accuracy corresponding to the selected circuit with another type of electronic elements with low accuracy when determining all of the electronic elements with the low accuracy corresponding to the selected circuit are ineligible. The electronic device 1 further determines which another type of the electronic elements with low accuracy are eligible, and controls the display unit 3 to display the information of the determined another type of the electronic elements.

In the embodiment, the electronic device 1 includes a processor 10 and a storage unit 20. An electronic element design system 30 is applied on the electronic device 1. In the embodiment, the electronic element design system 30 includes an obtaining module 31, an eligibility determining module 32, a searching module 33, an electronic element determining module 34, and a display control module 35. One or more programs of the above function modules may be stored in the storage unit 20 and executed by the processor 10. In general, the word “module,” as used herein, refers to logic embodied in hardware or firmware, or to a collection of software instructions, written in a programming language. The software instructions in the modules may be embedded in firmware, such as in an erasable programmable read-only memory (EPROM) device. The modules described herein may be implemented as either software and/or hardware modules and may be stored in any type of computer-readable medium or other storage device. For example, the processor 10 can be a central processing unit, a digital processor, a single chip. For example, the storage unit can be a hard disk, a compact disk, a flash memory.

In the embodiment, the storage unit 20 stores a bill of material (BOM) table. The BOM table records the information of electronic elements. In the embodiment, the information of electronic elements includes the types of electronic elements, the model numbers corresponding to each type of the electronic element, and the parameters corresponding to each model number of the electronic element. The storage unit 20 stores a number of circuit diagrams, a number of transfer functions corresponding to the circuit diagrams, a number of accuracies of the electronic elements, and a number of reference rules corresponding to the circuit diagrams. Each circuit diagram consists of a number of electronic elements. The circuit diagrams, the transfer functions, the accuracies, and the reference rules are pre-stored in the storage unit 20. Each circuit diagram corresponds to one transfer function, and one reference rule. In the embodiment, the accuracies of the electronic elements of one circuit diagram are the same, namely each circuit diagram consists of a number of electronic elements with a same accuracy. In other embodiments, the accuracy of different type of electronic elements in a circuit diagram can be different, or the accuracies of the electronic elements in each circuit diagram are the same. A user can select the needed parameters to test the needed function, for example, the selecting of parameter of the temperature coefficient and the initial tolerance can represent to test the environment influence. The reference rule includes, but is not limited to, a target value, an upper threshold of the target value, and a lower threshold of the target value. The target value includes, but is not limited to, a target output voltage, a target overvoltage protection value, and a target overcurrent protection value. The storage unit 20 further stores a reference element range of the element value of the electronic elements including a lower threshold (for example, 80%) and an upper threshold (for example, 120%). In the embodiment, the reference element ranges of the element values of the electronic elements in different circuit are the same. In other embodiments, the reference element ranges of the electronic elements in different circuit are different.

The obtaining module 31 obtains a transfer function corresponding to a selected circuit diagram in response to the user operation to select the circuit diagram. The obtaining module 31 further determines the electronic elements corresponding to the selected circuit diagram, determines the accuracy of the determined electronic elements, and determines the information of the determined electronic elements with the determined accuracy in the BOM table. The obtaining module 31 further determines the information of the determined electronic elements corresponding to one or more selected parameters in the determined information of the determined electronic elements with the determined accuracy in response to the user operation to select one or more parameters. In addition, the obtaining module 31 obtains the determined information of the determined electronic elements corresponding to the one or more selected parameters. The parameters of the obtained information of the determined electronic elements only include the selected one or more parameters.

The eligibility determining module 32 determines the parameters of each model number of each type of the electronic element with the determined accuracy according to the obtained information of the determined electronic elements. In addition, the eligibility determining module 32 inputs all the determined parameters of one model number of each type of electronic element with the determined accuracy into the obtained transfer function one by one to generate a number of real circuit values. The eligibility determining module 32 further compares each real circuit value with the reference rule corresponding to the selected circuit diagram to determine whether none of the electronic elements with the determined accuracy corresponding to the selected circuit diagram is eligible. If no real circuit value matches the reference rule, the eligibility determining module 32 determines that none of the electronic elements with the determined accuracy corresponding to the selected circuit diagram is eligible.

The searching module 33 determines the element value of each type of electronic element with the determined accuracy corresponding to the selected circuit diagram when no electronic elements with the determined accuracy corresponding to the selected circuit diagram are eligible. In addition, the searching module 33 calculates an element value range of the corresponding type of the electronic elements with the determined accuracy, by multiplying the determined element value of each type of electronic element with the stored reference element range of the element value of the corresponding electronic elements. For example, the selected circuit diagram can employ a capacitor and two resistors. The capacitance of the capacitor can be 0.8 farads, the resistance of a first resistor can be 422 ohms, and the resistance of a second resistor can be 2150 ohms. Moreover, the reference element range is 80%-120%. Thus, a lower threshold of the capacitance range of the capacitor is a product obtained by multiplying 0.8 farads by 80%, namely 0.64 farads, and an upper threshold of the capacitance range of the capacitor is a product obtained by multiplying 0.8 farads by 120%, namely 0.96 farads, that is, the capacitance range of the capacitor is from 0.64 farads to 0.96 farads. A lower threshold of the resistance range of the first resistor is a product obtained by multiplying 422 ohms by 80%, namely 337.6 ohms, and an upper threshold of the resistance range of the first resistor is a product obtained by multiplying 422 ohms by 120%, namely 506.4 ohms, that is, the resistance range of the first resistor is from 337.6 ohms to 506.4 ohms. A lower threshold of the resistance range of the second resistor is a product obtained by multiplying 2150 ohms by 80%, namely 1720 ohms. An upper threshold of the resistance range of the second resistor is a product obtained by multiplying 2150 ohms by 120%, namely 2580 ohms, that is, the resistance range of the second resistor is from 1720 ohms to 2580 ohms.

The searching module 33 further searches the BOM table to determine groups of electronic elements, each of which includes different types of electronic elements whose element value is in the corresponding determined element values range of the corresponding type of the electronic element. For better understanding of the description, take the example described above for further illustration, that is, the capacitance range of the capacitor is from 0.64 farads to 0.96 farads, the resistance range of the first resistor is from 337.6 ohms to 506.4 ohms, and the resistance range of the second resistor is from 1720 ohms to 2580 ohms. Accordingly, the searching module 33 determines that capacitors with capacitances 0.7 farads and 0.8 farads form a first group, resistors with resistances 402 ohms, 407 ohms, 412 ohms, 417 ohms, 422 ohms, 427 ohms, 432 ohms, and 437 ohms form a second group, and resistors with resistances 2080 ohms, 2130 ohms, 2100 ohms, 2150 ohms, 2180 ohms, 2210 ohms, and 2230 ohms form a third group. The searching module 33 determines the accuracy of the groups of electronic elements corresponding to the selected circuit diagram and determines the information of the determined groups of electronic elements with the determined accuracy in the bill of material table. The searching module 33 further determines the information of the determined groups of electronic elements corresponding to a selected one or more parameter in the determined information of the determined groups of electronic elements with the determined accuracy, and obtains the determined information of the determined groups of electronic elements corresponding to the selected one or more parameters.

The electronic element determining module 34 determines the parameters of each model number of each group of electronic element with the determined accuracy according to the obtained information of the determined group of electronic elements, and inputs all the determined parameters of one model number of each group of electronic element with the determined accuracy into the obtained transfer function one by one to generate a number of actual values. The electronic element determining module 34 compares each actual value with the reference rule corresponding to the selected circuit diagram to determine whether one or more actual values satisfy the reference rule. The electronic element determining module 34 further determines the model numbers of the electronic elements in the corresponding group of electronic elements corresponding to each determined actual value when one or more actual values satisfy the reference rule, and determines that the electronic elements with the determined model numbers corresponding to each determined actual value are eligible. If one or more actual values match the reference rule, the electronic element determining module 34 determines that one or more actual values satisfy the reference rule. If no actual value matches the reference rule, the electronic element determining module 34 determines that no actual value satisfies the reference rule.

The display control module 35 controls the display unit 3 to display the information of the electronic element with the determined model number corresponding to each determined actual value. For example, the display control module 35 can control the display unit 3 to simultaneously display the information of the capacitor with model number 111111, the information of the resistor with model number 121212, and the information of the resistor with model number 131313. In addition, the information of the capacitor with model number 111112, the information of the resistor with model number 121211, and the information of the resistor with model number 131411.

In the embodiment, the electronic element determining module 34 further determines which actual value is closest to the reference rule, determines the model numbers of the electronic elements corresponding to the determined actual value, and determines that the electronic elements with the determined model numbers corresponding to the determined actual value are eligible. Accordingly, the display control module 35 controls the display unit 3 to display the information of the determined electronic elements with the determined model numbers corresponding to the determined actual value.

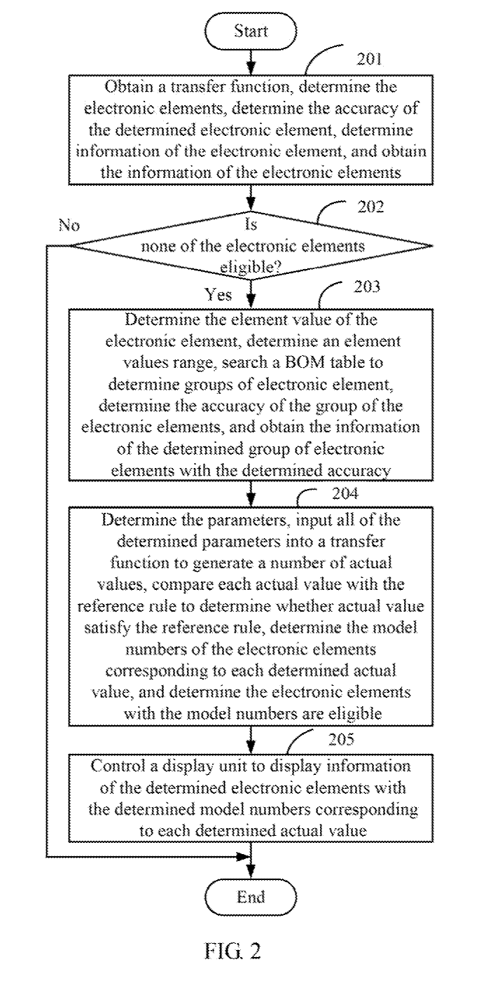

FIG. 2 illustrates an electronic element design method in accordance with an exemplary embodiment.

In 201, the obtaining module obtains a transfer function corresponding to a selected circuit diagram in response to the user operation to select the circuit diagram. The obtaining module further determines the electronic elements corresponding to the selected circuit diagram, determines the accuracy of the determined electronic elements, and determines the information of the determined electronic elements with the determined accuracy in the BOM table. The obtaining module further determines the information of the determined electronic elements corresponding to one or more selected parameters in the determined information of the determined electronic elements with the determined accuracy in response to the user operation to select one or more parameters. In addition, the obtaining module obtains the determined information of the determined electronic elements corresponding to the one or more selected parameters.

In 202, the eligibility determining module determines the parameters of each model number of each type of the electronic element with the determined accuracy according to the obtained information of the determined electronic elements. In addition, the eligibility determining module inputs all the determined parameters of one model number of each type of electronic element with the determined accuracy into the obtained transfer function one by one to generate a number of real circuit values. The eligibility determining module further compares each real circuit value with the reference rule corresponding to the selected circuit diagram to determine whether none of the electronic elements with the determined accuracy corresponding to the selected circuit diagram is eligible. If none of the electronic elements with the determined accuracy corresponding to the selected circuit diagram is eligible, the procedure goes to 203. If one electronic element with the determined accuracy corresponding to the selected circuit diagram is eligible, the procedure stops at 202. In the embodiment, if no real circuit values match the reference rule, the eligibility determining module determines that no electronic elements with the determined accuracy corresponding to the selected circuit diagram are eligible. Otherwise, the eligibility determining module determines that any electronic elements with the determined accuracy corresponding to the selected circuit diagram are eligible.

In 203, the searching module determines the element value of each type of electronic element with the determined accuracy corresponding to the selected circuit diagram. The searching modules calculates an element value range of the corresponding type of the electronic elements with the determined accuracy, by multiplying the determined element value of each type of electronic element with the stored reference element range. The searching module searches the BOM table to determine groups of electronic elements, each of which includes different types of electronic elements whose element values is in the corresponding determined element values range of the corresponding type of the electronic element. The searching module further determines the accuracy of the groups of electronic elements corresponding to the selected circuit diagram, determines the information of the determined groups of electronic elements with the determined accuracy in the BOM table. The searching module determines the information of the determined groups of electronic elements corresponding to a selected one or more parameter in the determined information of the determined groups of electronic elements with the determined accuracy, and obtains the determined information of the determined groups of electronic elements corresponding to the selected one or more parameters.

In 204, the electronic element determining module determines the parameters of each model number of each group of electronic element with the determined accuracy according to the obtained information of the determined group of electronic elements, and inputs all the determined parameters of one model number of each group of electronic elements with the determined accuracy into the obtained transfer function one by one to generate a number of actual values. The electronic element determining module compares each actual value with the reference rule corresponding to the selected circuit diagram to determine whether one or more actual values satisfy the reference rule. The electronic element determining module further determines the model numbers of the electronic elements in the corresponding group of electronic elements corresponding to each determined actual value when one or more actual values satisfy the reference rule, and determines that the electronic elements with the determined model numbers corresponding to each determined actual value are eligible. If none of actual values match the reference rule corresponding to the selected circuit diagram, the procedure stops at 204.

In 205, the display control module controls the display unit to display the information of the electronic element with the determined model number corresponding to each determined actual value.

In this way, different type of electronic elements with low accuracy can be employed to replace the electronic elements with low accuracy corresponding to the selected circuit diagram, to satisfy the need of the circuit. Thus, electronic elements with high accuracy do not need to be employed, which saves money.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An electronic device connected to an input unit and a display unit, comprising:
a storage unit storing a bill of material table, a number of circuit diagrams, a number of transfer functions corresponding to the circuit diagrams, a number of accuracies of the electronic elements, and a number of reference rules corresponding to the electronic elements; the bill of material table recording information of the electronic elements, the information of the electronic elements comprising types of the electronic elements, model numbers corresponding to each type of the electronic elements, and parameters corresponding to the electronic element with each model number; each circuit diagram corresponding to one transfer function, one accuracy of the electronic element, and one reference rule;
a processor;
one or more programs stored in the storage unit, executed by the processor, the one or more programs comprising:
a searching module configured to:
determine an element value of each type of electronic element with a determined accuracy corresponding to a selected circuit diagram;
determine an element value range of the corresponding electronic elements with the determined accuracy, by multiplying the determined element value of each type of electronic element with a stored reference element range of the element value of the corresponding electronic elements;
search the bill of material table to determine groups of electronic element, each of which comprises different types of electronic elements whose element value is in the corresponding determined element values range of the corresponding electronic elements;
determine the accuracy of the determined groups of electronic elements corresponding to the selected circuit diagram;
determine the information of the determined groups of electronic elements with the determined accuracy in the bill of material table;
determine the information of the determined groups of electronic elements corresponding to a selected one or more parameter in the determined information of the determined groups of electronic elements with the determined accuracy; and
obtain the information of the determined groups of electronic elements corresponding to a selected one or more parameters;
an electronic element determining module configured to:
determine the parameters of each model number of each group of electronic element with the determined accuracy according to the obtained information of the determined group of electronic elements;
input all the determined parameters of one model number of each group of electronic element with the determined accuracy into an obtained transfer function one by one to generate a number of actual values;
compare each actual value with a stored reference rule corresponding to the selected circuit diagram to determine whether one or more actual values satisfy the reference rule, determine the model numbers of the electronic elements in the corresponding group of electronic elements corresponding to each determined actual value; and
determine that the electronic elements with the determined model numbers corresponding to each determined actual value are eligible; and
a display control module configured to control the display unit to display the information of the electronic element with the determined model numbers corresponding to each determined actual value.

2. The electronic device as described in claim 1, further comprising an obtaining module, wherein the obtaining module is configured to:
obtain a transfer function corresponding to a selected circuit diagram in response to the user operation to select the circuit diagram; and
determine the electronic elements corresponding to the selected circuit diagram, and determine the accuracy of the determined electronic elements corresponding to the selected circuit diagram.

3. The electronic device as described in claim 2, further comprising an eligibility determining module, wherein: the obtaining module is further configured to:
determine the information of the determined electronic elements with the determined accuracy in the bill of material table;
determine the information of the determined electronic elements corresponding to one or more selected parameter in the determined information of the determined electronic elements with the determined accuracy in response to the user operation to select one or more parameters; and
obtain the determined information of the determined electronic elements corresponding to the one or more selected parameters;
the eligibility determining module is configured to:
determine the parameters of each model number of each type of the electronic element with the determined accuracy according to the obtained information of the determined electronic elements;
input all the determined parameters of one model number of each type of electronic element with the determined accuracy into the obtained transfer function one by one to generate a number of real circuit values; and
compare each real circuit value with the reference rule corresponding to the selected circuit diagram to determine whether none of the electronic elements with the determined accuracy corresponding to the selected circuit diagram is eligible; and
the searching module is accordingly configured to determine the element value of each type of electronic element with the determined accuracy corresponding to the selected circuit diagram when none of the electronic elements with the determined accuracy corresponding to the selected circuit diagram is eligible.

4. The electronic device as described in claim 1, wherein the electronic element determining module is further configured to:
determine which actual value is mostly close to the reference rule, determine the model numbers of the electronic elements corresponding to the determined actual value;
determine that the electronic elements with the determined model numbers corresponding to the determined actual value are eligible; and
the display control module is accordingly configured to control the display unit to display the information of the determined electronic elements with the determined model numbers corresponding to the determined actual value.

5. An electronic element design method comprising: determining an element value of each type of electronic element with a determined accuracy corresponding to a selected circuit diagram;
determining an element value range of the corresponding electronic elements with the determined accuracy, by multiplying the determined element value of each type of electronic element with a stored reference element range of the element value of the corresponding electronic elements;
searching a stored bill of material table to determine groups of electronic elements, each of which comprises different types of electronic elements whose element value is in the corresponding determined element values range of the corresponding electronic elements;
determining the accuracy of the groups of electronic elements corresponding to the selected circuit diagram;
determining the information of the determined groups of electronic elements with the determined accuracy in the bill of material table;
determining the information of the determined groups of electronic elements corresponding to a selected one or more parameter in the determined information of the determined groups of electronic elements with the determined accuracy;
obtaining the determined information of the determined groups of electronic elements corresponding to a selected one or more parameters where the information of the electronic elements comprising types of the electronic element, model numbers corresponding to each type of the electronic element, and parameters corresponding to the electronic elements with each model number;
determining the parameters of each model number of each group of electronic element with the determined accuracy according to the obtained information of the determined group of electronic elements;
inputting all the determined parameters of one model number of each group of electronic element with the determined accuracy into an obtained transfer function one by one to generate a number of actual values;
comparing each actual value with a stored reference rule corresponding to the selected circuit diagram to determine whether one or more actual values satisfy the reference rule;
determining the model numbers of the electronic elements in the corresponding group of electronic elements corresponding to each determined actual value when one or more actual values satisfy the reference rule;
determining that the electronic elements with the determined model numbers corresponding to each determined actual value are eligible; and
controlling a display unit to display the information of the determined electronic elements with the determined model numbers corresponding to each determined actual value.

6. The electronic element design method as described in claim 5, wherein the method further comprises:
obtaining a transfer function corresponding to a selected circuit diagram in response to the user operation to select the circuit diagram; and
determining the electronic elements corresponding to the selected circuit diagram, and determining the accuracy of the determined electronic elements corresponding to the selected circuit diagram.

7. The electronic element design method as described in claim 6, wherein the method further comprises:
determining the information of the determined electronic elements with the determined accuracy in the bill of material table;
determining the information of the determined electronic elements corresponding to one or more selected parameters in the determined information of the determined electronic elements with the determined accuracy in response to the user operation to select one or more parameters;
obtaining the determined information of the determined electronic elements corresponding to the one or more selected parameters;
determining the parameters of each model number of each type of the electronic element with the determined accuracy according to the obtained information of the determined electronic elements;
inputting all the determined parameters of one model number of each type of electronic element with the determined accuracy into the obtained transfer function one by one to generate a number of real circuit values;
comparing each real circuit value with the reference rule corresponding to the selected circuit diagram to determine whether none of the electronic elements with the determined accuracy corresponding to the selected circuit diagram is eligible; and
determining element value of each type of electronic element with the determined accuracy corresponding to the selected circuit diagram when none of the electronic elements with the determined accuracy corresponding to the selected circuit diagram is eligible.

8. The electronic element design method as described in claim 5, wherein the method further comprises:
determining which actual value is mostly close to the reference rule, determining the model numbers of the electronic elements corresponding to the determined actual value;
determining that the electronic elements with the determined model numbers corresponding to the determined actual value are eligible; and
accordingly controlling the display unit to display the information of the determined electronic elements with the determined model numbers corresponding to the determined actual value.

9. A non-transitory storage medium storing a set of instructions, the set of instructions capable of being executed by a processor of an electronic device, causing the electronic device to perform an electronic element assign method, the method comprising:
determining an element value of each type of electronic element with a determined accuracy corresponding to a selected circuit diagram;
determining an element value range of the corresponding electronic elements with the determined accuracy, by multiplying the determined element value of each type of electronic element with a stored reference element range of the element value of the corresponding electronic elements;
searching a stored bill of material table to determine groups of electronic elements, each of which comprises different types of electronic elements whose element value is in the corresponding determined element values range of the corresponding electronic elements;
determining the accuracy of the groups of electronic elements corresponding to the selected circuit diagram;
determining the information of the determined groups of electronic elements with the determined accuracy in the bill of material table;
determining the information of the determined groups of electronic elements corresponding to a selected one or more parameter in the determined information of the determined groups of electronic elements with the determined accuracy;
obtaining the determined information of the determined groups of electronic elements corresponding to a selected one or more parameters; the information of the electronic elements comprising types of the electronic element, model numbers corresponding to each type of the electronic element, and parameters corresponding to the electronic elements with each model number;
determining the parameters of each model number of each group of electronic element with the determined accuracy according to the obtained information of the determined group of electronic elements;
inputting all the determined parameters of one model number of each group of electronic element with the determined accuracy into an obtained transfer function one by one to generate a number of actual values;
comparing each actual value with a stored reference rule corresponding to the selected circuit diagram to determine whether one or more actual values satisfy the reference rule;
determining the model numbers of the electronic elements in the corresponding group of electronic elements corresponding to each determined actual value when one or more actual values satisfy the reference rule;
determining that the electronic elements with the determined model numbers corresponding to each determined actual value are eligible; and
controlling a display unit to display the information of the determined electronic elements with the determined model numbers corresponding to each determined actual value.

10. The non-transitory storage medium as described in claim 9, wherein the method further comprises:
obtaining a transfer function corresponding to a selected circuit diagram in response to the user operation to select the circuit diagram; and
determining the electronic elements corresponding to the selected circuit diagram, and determining the accuracy of the determined electronic elements corresponding to the selected circuit diagram.

11. The non-transitory storage medium as described in claim 10, wherein the method further comprises:
determining the information of the determined electronic elements with the determined accuracy in the bill of material table;
determining the information of the determined electronic elements corresponding to one or more selected parameters in the determined information of the determined electronic elements with the determined accuracy in response to the user operation to select one or more parameters;
obtaining the determined information of the determined electronic elements corresponding to the one or more selected parameters;
determining the parameters of each model number of each type of the electronic element with the determined accuracy according to the obtained information of the determined electronic elements;
inputting all the determined parameters of one model number of each type of electronic element with the determined accuracy into the obtained transfer function one by one to generate a number of real circuit values;
comparing each real circuit value with the reference rule corresponding to the selected circuit diagram to determine whether none of the electronic elements with the determined accuracy corresponding to the selected circuit diagram is eligible; and
determining element value of each type of electronic element with the determined accuracy corresponding to the selected circuit diagram when none of the electronic elements with the determined accuracy corresponding to the selected circuit diagram is eligible.

12. The non-transitory storage medium as described in claim 9, wherein the method further comprises:
determining which actual value is mostly close to the reference rule, determining the model numbers of the electronic elements corresponding to the determined actual value;
determining that the electronic elements with the determined model numbers corresponding to the determined actual value are eligible; and
accordingly controlling the display unit to display the information of the determined electronic elements with the determined model numbers corresponding to the determined actual value.
